(19) United States
(12) Patent Application Publication
(10) Pub. No.: US 2015/0324157 A1
(43) Pub. Date: Nov. 12, 2015

(54) PRINTER DRIVER AND PROHIBITION PROCESS CONTROL METHOD FOR PRINTER DRIVER

(71) Applicant: KONICA MINOLTA, INC., Tokyo (JP)

(72) Inventor: Yoshiyuki HARADA, Tokyo (JP)

(73) Assignee: KONICA MINOLTA, INC., Tokyo (JP)

(21) Appl. No.: 14/694,508

(22) Filed: Apr. 23, 2015

(30) Foreign Application Priority Data
May 8, 2014 (JP) 2014-096482

(51) Int. Cl. G06F 3/12

(52) U.S. Cl. CPC G06F 3/1255; G06F 3/1205; G06F 3/121; G06F 3/1258; G06F 3/1276; H04N 2201/0094

(57) ABSTRACT

A printer driver which operates in a computer device issuing an instruction of printing to a printing device, and executes a prohibition process in a script language for verifying and solving prohibition that causes conflict between settings of printing functions of the printing device, under the printer driver, the computer device executes: a first process that calculates identity determination information beforehand from PrintTicket in a state where prohibition is not caused, and stores the calculated identity determination information; a second process that calculates identity determination information from the PrintTicket at a start of the prohibition process for the PrintTicket; and a third process that compares the identity determination information stored in the first process and the identity determination information calculated in the second process, wherein the first process through the third process are performed in this order.

The entire disclosure of Japanese Patent Application No. 2014-096482 filed on May 8, 2014 including description, claims, drawings, and abstract are incorporated herein by reference in its entirety.

### BACKGROUND OF THE INVENTION

1. Field of the Invention

The present invention relates to a printer driver and a prohibition process control method for a printer driver, and more particularly to a printer driver operating on an operating system (OS) of Windows (registered trademark, hereinafter not particularly mentioned), and a prohibition process control method for this printer driver.

2. Description of the Related Art

There are guidelines presented by Microsoft (registered trademark, hereinafter not particularly mentioned) Corporation to hardware manufacturers, concerning printer driver which operates on Windows OS. In conformity with the presented guidelines, hardware manufacturers are currently providing printer driver of Version 3 suitable for Windows 2000 to Windows 7.

Recently, Windows 8 and Server 2012 have appeared on the market as updated Windows OS. According to Windows 8, in particular, a UI (user interface) included therein has been changed to a tile-shaped user interface called a Metro style. To deal with this change, hardware manufacturers are now developing printer driver of Version 4 having new printer driver architecture.

A printer driver model of Version 4 is roughly divided into two layers: a Printer Driver core unit and a printing setting UI (User Interface) unit. These two layers are designed to realize process isolation from each other, and provided as individual units.

The Printer Driver core unit is an application providing printing functions. The Printer Driver core unit creates printing function information called PrintCapabilities, and printing setting information called PrintTicket, based on data file such as GPD (Generic Printer Description) defining the respective printing functions, and processes conflict between settings of the printing functions. On the other hand, the printing setting UI unit is an application independent from the Printer Driver core unit, and provides a printing setting screen based on PrintCapabilities and PrintTicket received from the Printer Driver core unit.

This type of printer driver determines conflict between the settings of the printing functions (hereinafter referred to as prohibition process) to allow correct performance of a printing process. However, this prohibition process causes a delay of the printing start when the time required for the prohibition process increases. For overcoming this problem, there is disclosed in JP 2012-226696 A, for example, a printing driver which processes information on a printing process of a printing device, the printing driver including: a conversion memory module which converts structured data describing printing prohibition settings in a structured language into prohibition setting data constituted by a multidimensional array of binary data, and stores the converted prohibition setting data in a memory unit; and an output module which makes prohibition condition determinations based on the stored prohibition setting data, and outputs the determination results. This printing driver converts the structured data into the prohibition setting data constituted by binary data so as to increase the speed of the prohibition process.

Printer driver of Version 3 executes the foregoing prohibition process in C/C++ or other languages, wherefore the required processing time is short. However, printer driver of Version 4 executes the prohibition process in a script language such as JavaScript (registered trademark, hereinafter not particularly mentioned), wherefore the processing time becomes long.

More specifically, printer driver of Version 4 calls a function called validatePrintTicket ( ) defined in JavaScript in response to an instruction of the prohibition process issued from an application or an OS, and verifies whether or not current setting values set in PrintTicket cause prohibition. In detecting prohibition based on this verification, the printer driver solves the detected prohibition, and returns a value indicating whether or not the detected prohibition has been solved to the application or the OS. Accordingly, this process requires a long time.

Moreover, the number of times the validatePrintTicket ( ) function is to be called for this process depends on the types of application or OS. It is probable that the validatePrinterTicket ( ) function is called a plurality of number of times for each execution of printing. In this case, the instruction of the prohibition process is repeatedly issued for handling identical PrintTicket. Consequently, the time required for the prohibition process further increases up to 5 to 10 times longer than the corresponding time required by an equivalent process executed in C/C++ or other languages. These problems are conspicuous in printer driver of Version 4. The delay of printing start increases as the prohibition process time becomes longer. The prolonged delay considerably deteriorates the user convenience.

### SUMMARY OF THE INVENTION

The present invention has been developed to solve the aforementioned problems. A main object of the present invention is to provide a printer driver and a prohibition process control method for a printer driver capable of increasing efficiency of a prohibition process executed for determining conflict between settings of printing functions.

To achieve the abovementioned object, according to an aspect, a printer driver reflecting one aspect of the present invention operates in a computer device issuing an instruction of printing to a printing device, and executes a prohibition process in a script language for verifying and solving prohibition that causes conflict between settings of printing functions of the printing device, under the printer driver, the computer device executing: a first process that calculates identity determination information beforehand from PrintTicket in a state where prohibition is not caused, and stores the calculated identity determination information; a second process that calculates identity determination information from the PrintTicket at a start of the prohibition process for the PrintTicket; and a third process that compares the identity determination information stored in the first process and the identity determination information calculated in the second process, wherein the first process through the third process are performed in this order, when the identity determination information stored in the first process and the identity determination information calculated in the second process agree with each other, the third process does not execute verification of prohibition, and when the identity determination information stored in the first process and the identity determination information calculated in the second process disagree with each other, the third process executes verification of prohibition, calculates identity determination information from the PrintTicket in a state where the prohibition has been solved, and additionally stores the calculated identity determination information.

To achieve the abovementioned object, according to an aspect, a prohibition process control method for a printer driver which operates in a computer device issuing an instruction of printing to a printing device, and executes a prohibition process in a script language for verifying and solving prohibition that causes conflict between settings of printing functions of the printing device, the method reflecting one aspect of the present invention comprises: a first process that calculates identity determination information beforehand from PrintTicket in a state where prohibition is not caused, and stores the calculated identity determination information; a second process that calculates identity determination information from the PrintTicket at a start of the prohibition process for the PrintTicket; and a third process that compares the identity determination information stored in the first process and the identity determination information calculated in the second process, wherein when the identity determination information stored in the first process and the identity determination information calculated in the second process agree with each other, the third process does not execute verification of prohibition, and when the identity determination information stored in the first process and the identity determination information calculated in the second process disagree with each other, the third process executes verification of prohibition, calculates identity determination information from the PrintTicket in a state where the prohibition has been solved, and additionally stores the calculated identity determination information.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a view schematically illustrating a configuration of a printing system according to an embodiment of the present invention;

FIG. 2 is a block diagram illustrating a configuration of a computer device according to the embodiment of the present invention;

FIG. 3 is a block diagram illustrating functions of the computer device according to the embodiment of the present invention;

FIG. 4 illustrates an example of a GPD file according to the embodiment of the present invention;

FIG. 5 is a flowchart describing a prohibition process executed by the computer device according to the embodiment of the present invention;

FIG. 6 is a flowchart describing the prohibition process (prohibition verification process) executed by the computer device according to the embodiment of the present invention;

FIG. 7 illustrates an example of PrintTicket (PrintTicket (1) corresponding to a verification target) according to the embodiment of the present invention;

FIG. 8 illustrates an example of PrintTicket (PrintTicket (2) obtained after the prohibition process for PrintTicket (1)) according to the embodiment of the present invention;

FIGS. 9A and 9B illustrate examples of a hash code table referred to in the prohibition process according to the embodiment of the present invention;

FIGS. 10A to 10C illustrate an example of PrintTicket including added hash values and referred to in the prohibition process according to the embodiment of the present invention;

FIG. 11 illustrates an example of a setting item list referred to in the prohibition process according to the embodiment of the present invention;

FIG. 12 illustrates an example of a setting state table (in a state describing setting values before execution of the prohibition process for setting items in FIG. 11) according to the embodiment of the present invention;

FIG. 13 illustrates an example of a setting state table (in a state describing setting values after execution of the prohibition process for setting items in FIG. 11) according to the embodiment of the present invention;

FIG. 14 illustrates an example of prohibition condition equations referred to in the prohibition process according to the embodiment of the present invention; and

FIGS. 15A to 15C are views illustrating effects of prohibition process controls according to the embodiment of the present invention, FIG. 15A shows an effect of a hash value comparison process, FIG. 15B shows an effect of a prohibition process executed with reference to the setting state table, and FIG. 5C shows an effect of both of these processes.

### DESCRIPTION OF THE PREFERRED EMBODIMENTS

Hereinafter, an embodiment of the present invention will be described with reference to the drawings. However, the scope of the invention is not limited to the illustrated examples.

As discussed above in the section of “Description of the Related Art”, printer driver suitable for Windows OS is currently provided by hardware manufacturers. In addition, printer driver of Version 4 for updated Windows OS, i.e., Windows 8 and Server 2012, is also under development.

According to printer driver of Version 4, a prohibition process needs to be executed in a script language such as JavaScript. In this case, the time required for the prohibition process becomes longer than the time required for an equivalent process executed in C/C++ or other languages. Particularly, validatePrintTicket ( ) corresponding to a function for verifying prohibition is called a plurality of number of times for each execution of printing to repeatedly verify prohibition for identical PrintTicket. In this case, the time required for the prohibition process increases, wherefore a delay of printing start may occur.

These problems are herein detailed with reference to practically measured data. Table 1 shows averages of five measurements of time required from a press of a printing button on a printing setting screen to completion of printing data creation, for both a case when the prohibition process is executed, and a case when the prohibition process is not executed. Measurement target test data “SP03P_AC.pdf” corresponds to 1st page, while “J9.doc” corresponds to 5th page. The measurements are performed under the environment of OS:Windows8 Pro, CPU:Intel® Core™ i5-2400@3.10 GHz, Memory:8.00 GB, HDD:400 GB (Remaining:100 GB), Application:Adobe reader 11.0.3, Application:Microsoft Word 2010.

TABLE 1

| | | PROHI- | | |
|---|---|---|---|---|
| | PROHI- | BITION | PROHI- | PROHI- |
| | BITION | PROCESS | BITION | BITION |
| | PROCESS | NOT | PROCESS | PROCESS |
| | EXECUTED | EXECUTED | TIME | TIME RATE |
| Document | (sec) | (sec) | (sec) | (%) |
| SP03P_AC.pdf | 13.58 | 4.4 | 9.18 | 67.6 |
| J9.doc | 9.53 | 4.95 | 4.58 | 48.06 |

According to the measurement target test data shown in Table 1, the proportion of the time required for the prohibition process (difference between the measurement time required when the prohibition process is executed and the measurement time required when the prohibition process is not executed) lies approximately in the range from 45% to 70% of the time required for completion of printing data creation when the prohibition process is executed. It is therefore considered that the proportion of the prohibition process time to the total printing process time is extremely large. Accordingly, reduction of the prohibition process time is essential for increasing the speed of the printing process.

In this point, however, conventional printer driver of Version 3 executes processing in C/C++. In this case, the required prohibition process time is only 1 second or shorter, wherefore no problem arises from the prohibition process. On the other hand, printer driver of Version 4 executes processing in a script language such as JavaScript. In this case, the prohibition process time increases, wherefore the prohibition process causes conspicuous problems. Particularly, it is known that the instruction of the prohibition process is issued a plurality of number of times from an OS or an application for handling identical PrintTicket. In this situation, the prohibition process is repeatedly executed for the identical PrintTicket, wherefore the prohibition process time further increases. Accordingly, reduction of the prohibition process time has been demanded to overcome these problems.

For meeting this demand, a printer driver according to an aspect of the present invention focuses on the fact that verification of prohibition is unnecessary when settings of printing functions do not change. The printer driver according to the aspect of the invention, which executes the prohibition process in a script language such as JavaScript, calculates and stores beforehand sets of information (collectively called identity determination information), such as hash values (pseudorandom numbers having a fixed length, calculated from original data by fixed calculation methods, and indicating characteristics of the corresponding data), and checksums (sums of numbers each indicating data within corresponding one of blocks divided from data), for PrintTicket not causing prohibition. At the start of the prohibition process for PrintTicket, the printer driver calculates identity determination information for this PrintTicket, and compares the calculated identity determination information with the identity determination information stored beforehand. When no difference is detected between the calculated identity determination information and the stored identity determination information, the printer driver skips verification of prohibition. The printer driver only verifies prohibition when detecting a difference between the calculated identity determination information and the stored identity determination information. In case of execution of verification, the printer driver calculates and stores identity determination information for the verified PrintTicket so as to utilize the calculated identity determination information for the next prohibition process.

Effects produced by this prohibition process control are herein explained. Table 2 shows averages of five measurements of time required from a press of a printing button on a printing setting screen to completion of printing data creation, for both a case when the prohibition process is executed, and a case when the prohibition process is not executed.

TABLE 2

| | BEFORE COMPLETION OF | | | | | |
|---|---|---|---|---|---|---|
| | PRINTING DATA CREATION | | | PROHIBITION PROCESS TIME | | |
| | BEFORE | AFTER | REDUCTION | BEFORE | AFTER | REDUCTION |
| | APPLICATION | APPLICATION | RATE | APPLICATION | APPLICATION | RATE |
| Document | (sec) | (sec) | (%) | (sec) | (sec) | (%) |
| SP03P_AC.pdf | 13.58 | 10.9 | 19.73 | 9.18 | 6.5 | 29.19 |
| J9.doc | 9.53 | 7.83 | 17.84 | 4.58 | 2.88 | 37.12 |

As apparent from Table 2, approximately 15% to 20% of reduction of the time required for completion of printing data creation, and approximately 30% to 40% of the time required for the prohibition process time are achievable when the foregoing prohibition process control is applied. This decrease in the time required for completion of printing data creation improves the performance.

### Embodiment

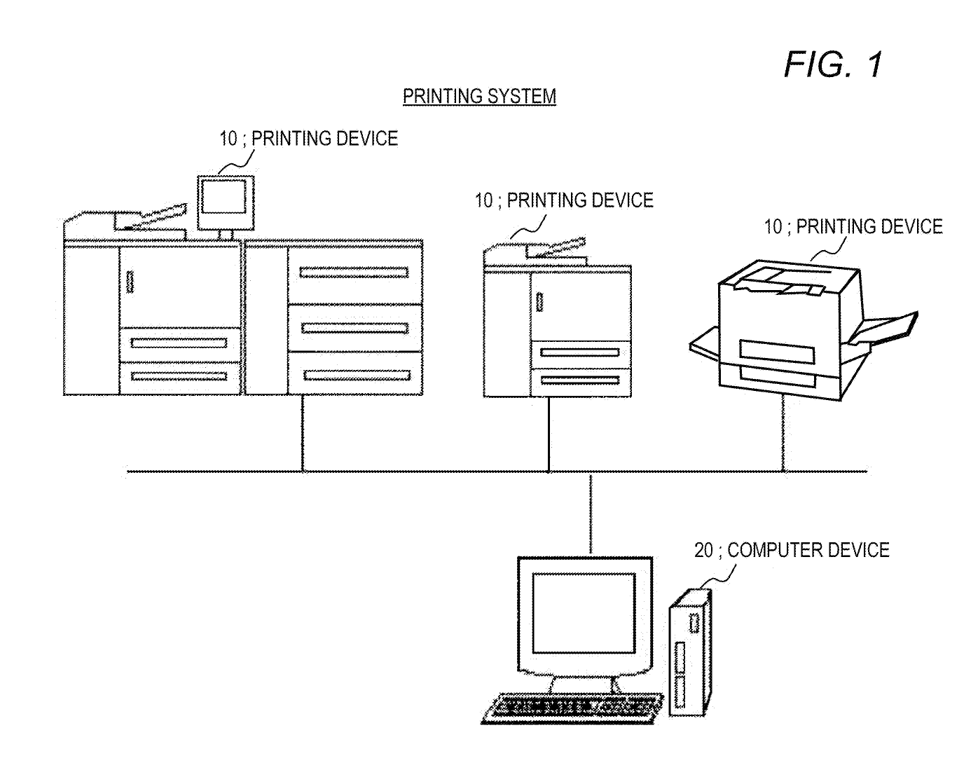

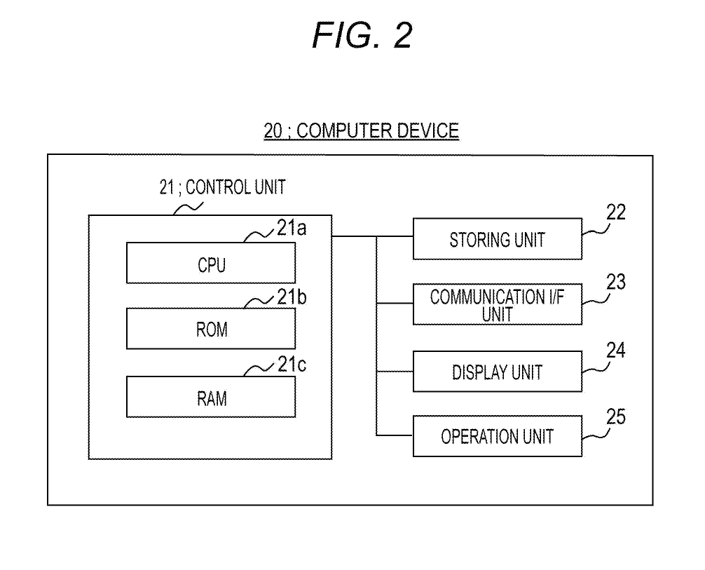

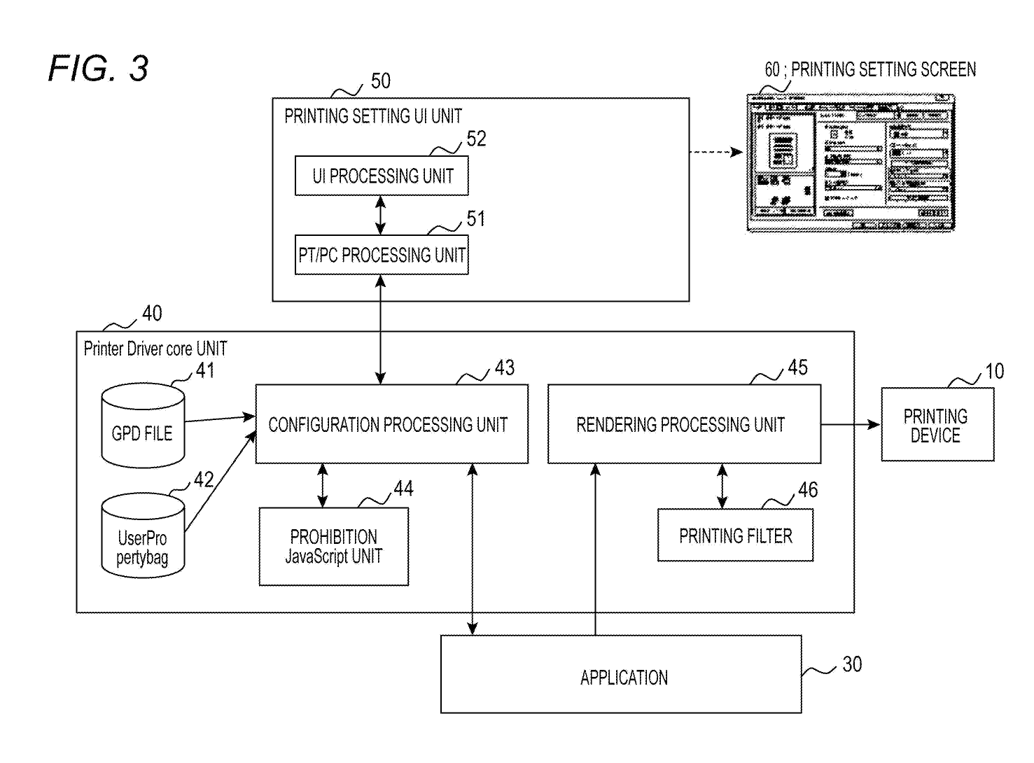

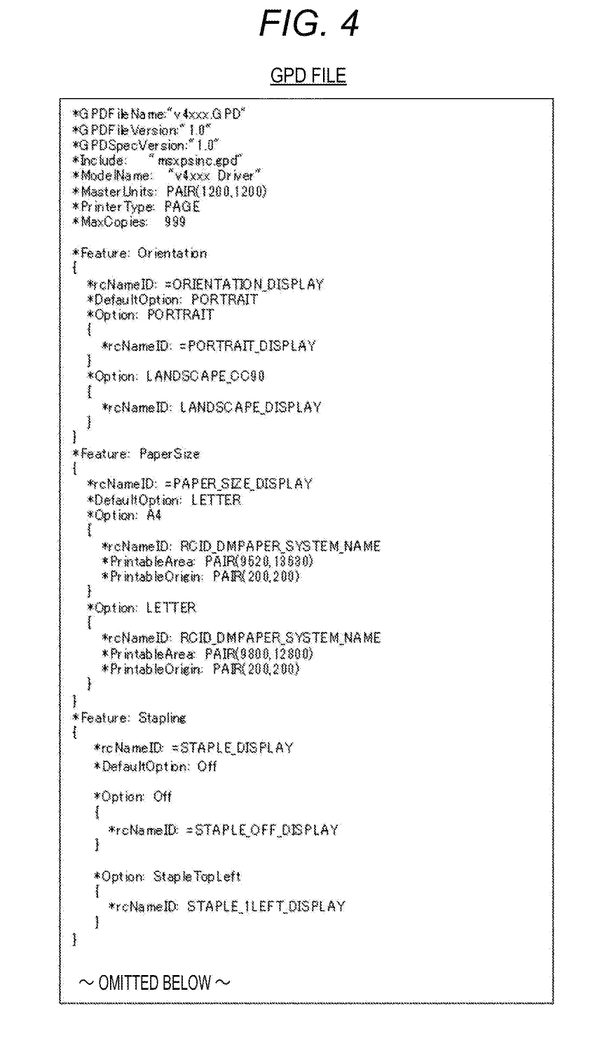

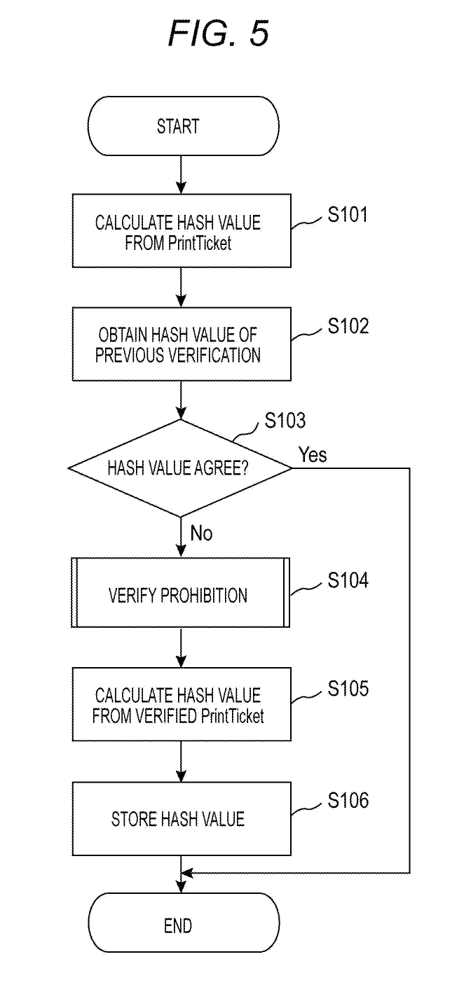

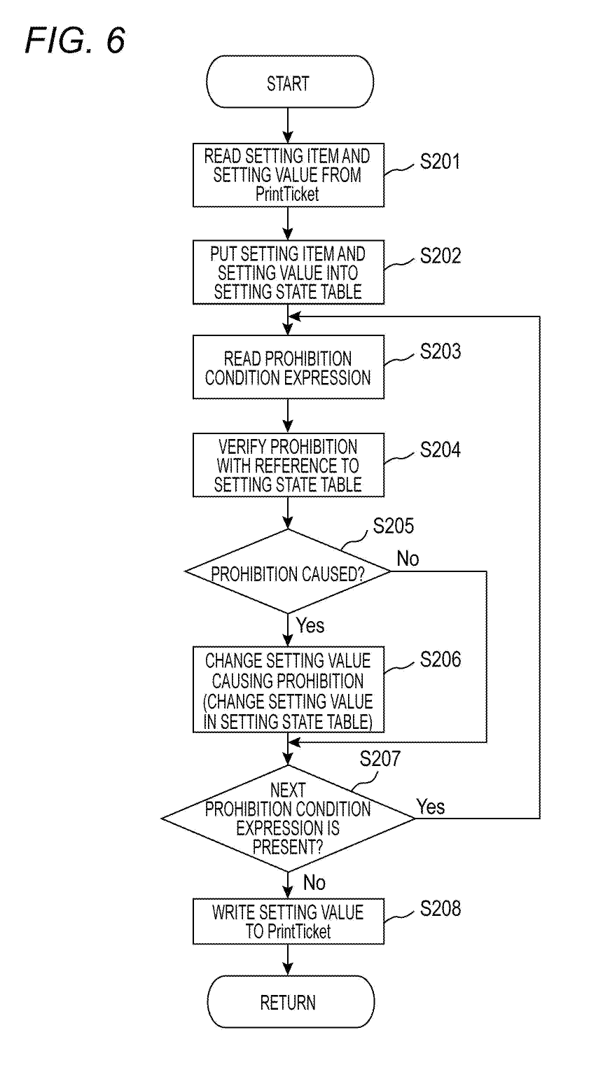

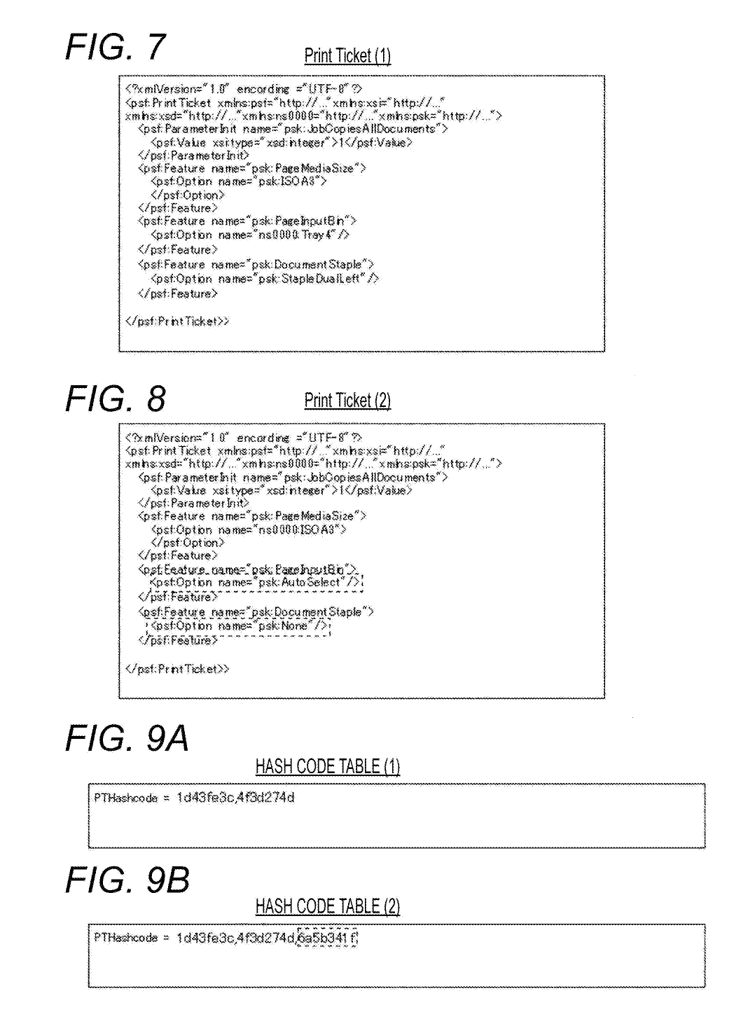

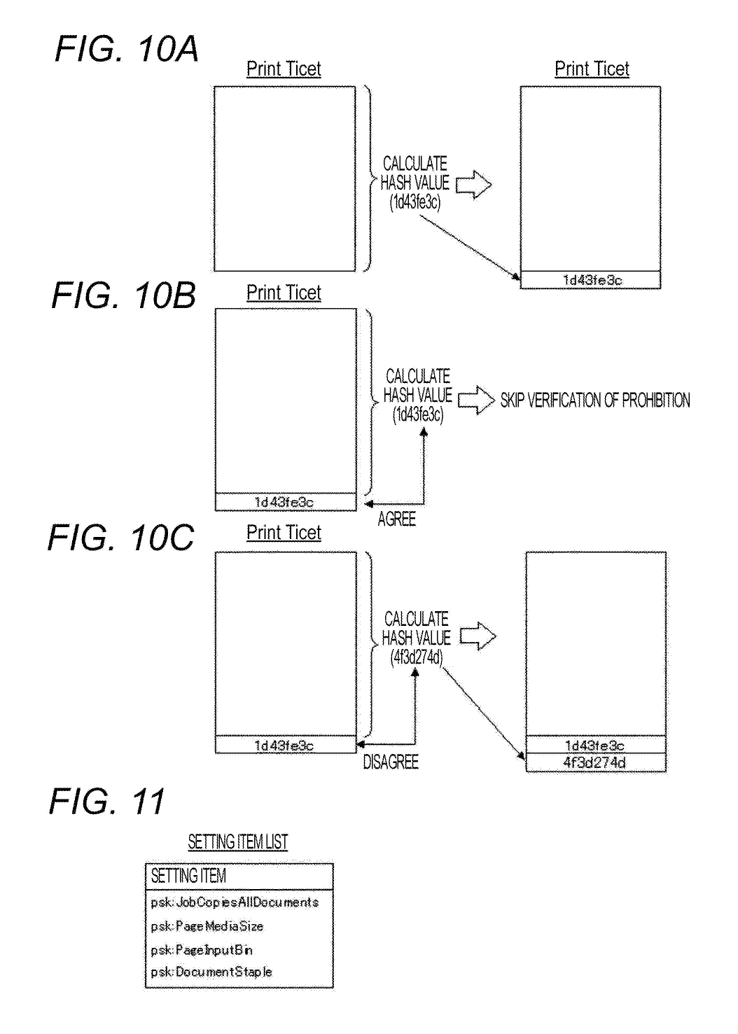

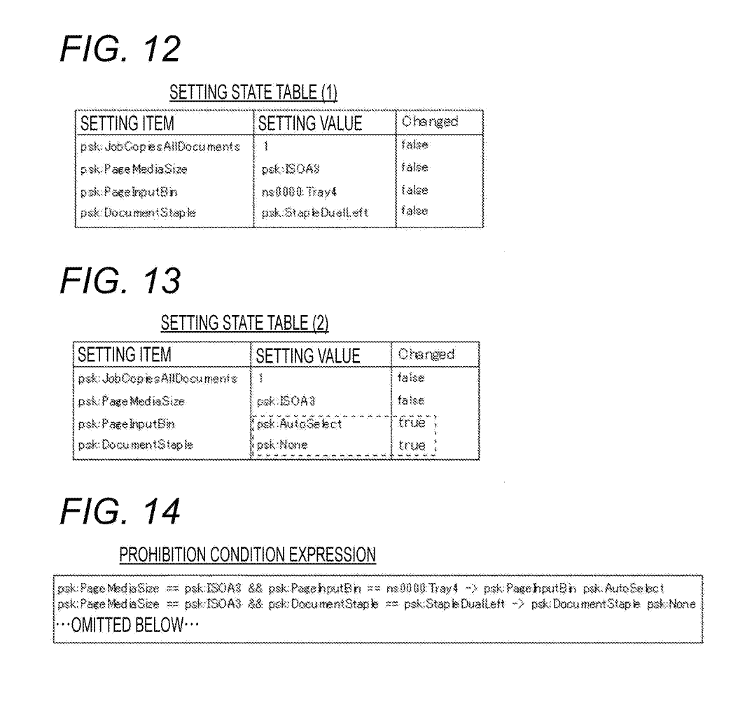

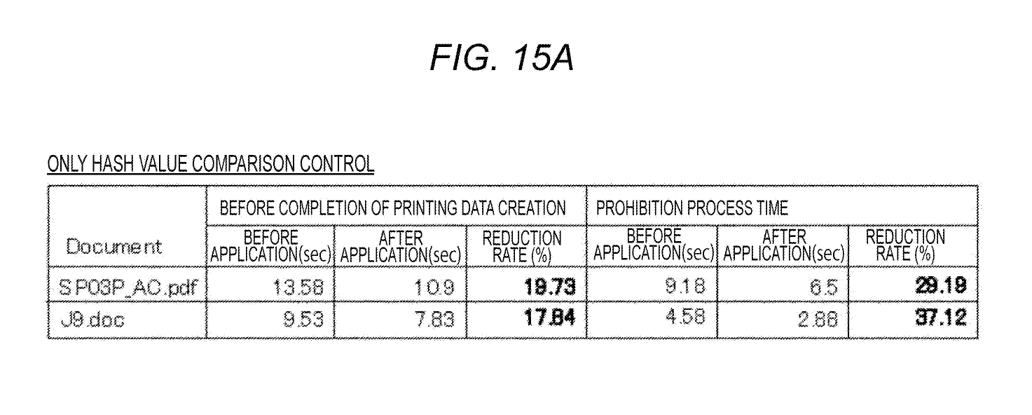

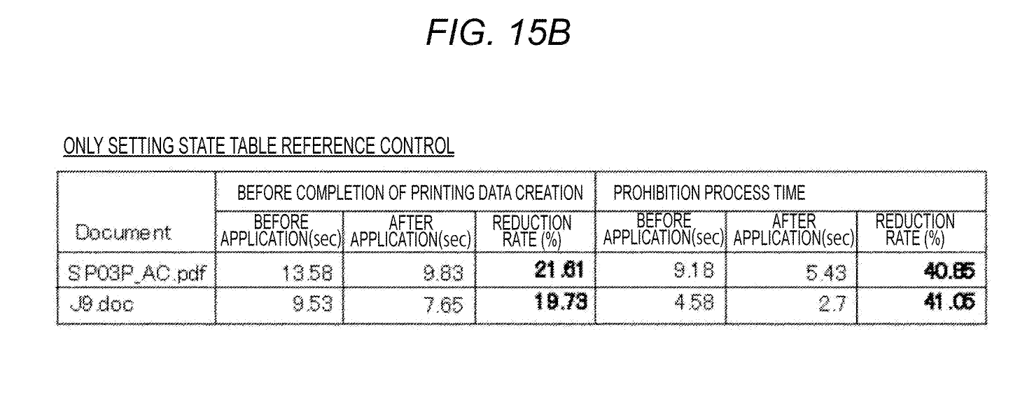

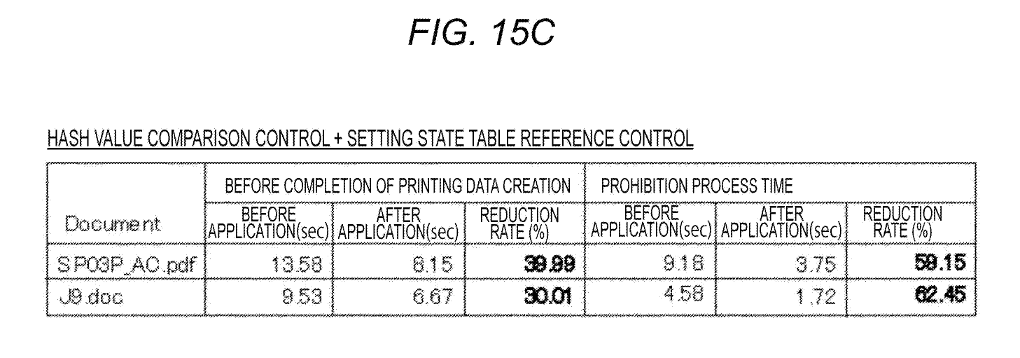

For more detailing the foregoing aspect of the present invention, a printer driver and a prohibition process control method for a printer driver according to an embodiment of the present invention are hereinafter described with reference to FIGS. 1 to 15C. FIG. 1 is a view schematically illustrating a configuration of a printing system according to this embodiment. FIG. 2 is a block diagram illustrating a configuration of a computer device according to this embodiment. FIG. 3 is a block diagram illustrating functions of the computer device. FIG. 4 illustrates an example of a GPD file. FIGS. 5 and 6 are flowcharts describing a prohibition process executed by the computer device according to this embodiment. FIGS. 7 and 8 illustrate examples of PrintTicket according to this embodiment. FIGS. 9A and 9B illustrate examples of a hash code table. FIGS. 10A to 10C illustrate examples of PrintTicket including added hash values. FIG. 11 illustrates an example of a setting item list. FIGS. 12 and 13 illustrate examples of a setting state table. FIG. 14 illustrates an example of prohibition condition expressions. FIGS. 15A to 15C illustrate effects of prohibition process controls according to this embodiment.

As illustrated in FIG. 1, the printing system according to this embodiment includes printing devices 10 each of which executes a printing process in accordance with a printing instruction, and a printing instruction device (referred to as a computer device 20) which issues a printing instruction. These devices are connected with each other via a wireless network such as LAN (Local Area Network), or a wired network such as USB (Universal Serial Bus).

Each of the printing devices 10 is constituted by an ordinary printer or an MFP (Multifunction Peripheral), for example, and has functions of analyzing printing data transmitted from the computer device 20, creating image data for each page through rasterization of each page, and printing an image on a sheet based on the image data by utilization of imaging processing such as electrophotographic method and electrostatic recording method.

The computer device 20 is constituted by a personal computer or a mobile device (such as smartphone and tablet-type device) operating on Windows OS, for example. As illustrated in FIG. 2, the computer device 20 includes a control unit 21, a storing unit 22, a communication I/F unit 23, a display unit 24, an operation unit 25, and others.

The control unit 21 includes a CPU (Central Processing Unit) 21a, and memories such as a ROM (Read Only Memory) 21b and a RAM (Random Access Memory) 21c. The CPU 21a reads, from the ROM 21b or the storing unit 22, a program for controlling operation of the computer device 20, an OS (Windows OS allowing operation of printer driver of Version 4 according to this embodiment), an application, a printer driver for controlling the printing devices 10 (for example, printer driver of Version 4 which executes a prohibition process in a script language such as JavaScript according to this embodiment). The CPU 21a loads the read program and the like into the RAM 21c to execute the program and the like. The application, a Printer Driver core unit, and a printing setting UI unit will be detailed later.

The storing unit 22 constituted by an HDD (Hard Disk Drive) or an SSD (Solid State Drive), for example, stores programs, document data, printing data and others.

The communication I/F unit 23 constituted by an NIC (Network Interface Card) or a modem, for example, communicates with the printing devices 10 for data transmission.

The display unit 24 constituted by an LCD (Liquid Crystal Display), for example, displays a screen of the application, a printing setting screen formed by the printing setting UI unit, and others.

The operation unit 25 constituted by a mouse, a keyboard, or a touch sensor formed on the display unit 24, for example, allows creation of documents, input of settings of the printing functions of the printing devices 10, and other operations.

FIG. 3 is a block diagram illustrating functions of the control unit 21 of the computer device 20. The control unit 21 of the computer device 20 functions as an application 30, a Printer Driver core unit 40, a printing setting UI unit 50, and others under programs executed by the CPU 21a.

The application 30 is a program operating on the OS (such as Microsoft Office operating on Windows OS), and creates document data which becomes a printing target. The OS and the application 30 issue, to the Printer Driver core unit 40, an instruction of a prohibition process for determining conflict between settings of the printing functions for each stage of the printing process.

The Printer Driver core unit 40 is a program operating on the OS, and issues a printing instruction to the printing devices 10 in linkage with the application 30 and the printing setting UI unit 50. The Printer Driver core unit 40 includes a GPD file 41, a UserPropertybag 42, a configuration processing unit 43, a prohibition JavaScript unit 44, a rendering processing unit 45, a printing filter 46, and others.

The GPD file 41 provided as one of configuration files defines respective printing functions of each of the printing devices 10. The UserPropertybag 42 is a data storing area which stores a hash code table, a setting item list, a setting state table, prohibition condition expressions, and others. The configuration processing unit 43 creates PrintCapabilities (printing function information) describing, in a structured language such as XML (Extensible Markup Language), setting items of printing functions acceptable from a user and acceptable setting values, and also creates PrintTicket (printing setting information) describing, in a structured language such as XML, a setting value selected by the user from the setting values described in PrintCapabilities. In addition, the configuration processing unit 43 calls the prohibition JavaScript unit 44. These operations of the configuration processing unit 43 are performed based on the GPD file 41.

The prohibition JavaScript unit 44 processes conflict between the settings of the printing functions caused in PrintTicket or PrintCapabilities. For example, when a setting of a first function (such as imposition function) and a setting of a second function (such as punch function) are incompatible with each other, the setting of one of these functions is changed to such a setting which is compatible with the setting of the other function. Moreover, the prohibition JavaScript unit 44 allows editing for PrintTicket and PrintCapabilities in JavaScript. The rendering processing unit 45 converts a printing command issued from the application 30 into a language interpretable by the printing devices 10 (PDL: Page Description Language, for example). The printing filter 46 edits a drawing command and a printing control command at the time of rendering.

The printing setting UI unit 50 is a program operating on the OS, and includes a PT/PC processing unit 51, a UI processing unit 52, and others.

The PT/PC processing unit 51 processes (interprets) PrintTicket and PrintCapabilities received from the Printer Driver core unit 40. The UI processing unit 52 forms and displays a printing setting screen 60 based on the contents of PrintTicket and PrintCapabilities interpreted by the PT/PC processing unit 51.

FIG. 4 illustrates an example of the GPD file 41. The printing functions are defined at “*Feature:” in the figure. The setting values of the respective printing functions are defined at “*Option:” as a lower-order element of “*Feature:”. The printing functions defined in this embodiment are Orientation, PaperSize, and Staple.

According to this embodiment, the configuration file which defines the printing functions is the GPD file 41. However, the prohibition process control method according to this embodiment is similarly applicable to a structure which includes a PPD (PostScript Printer Description) file as the configuration file.

Operation of the printer driver (prohibition process control) according to this embodiment is hereinafter described. The CPU 21a reads the printer driver stored in the ROM 21b, loads the printer driver into the RAM 21c, and executes the printer driver to perform respective steps shown in the flowcharts in FIGS. 5 and 6. Discussed herein is a process executed by validatePrintTicket ( ), i.e., a function included in the prohibition JavaScript unit 44 and called by the configuration processing unit 43. The validatePrintTicket ( ) is a function called when the OS or the application 30 determines that verification of PrintTicket is necessary. The validatePrintTicket ( ) is called on occasions of a change of the printing settings, and execution of printing. During execution of printing, this function is called a plurality of number of times.

Initially, the prohibition JavaScript unit 44 calculates identity determination information (hash value in this embodiment) from PrintTicket corresponding to a verification target (S101). FIG. 7 illustrates an example of PrintTicket corresponding to a verification target. PrintTicket (1) contains printing settings of “JobCopiesAllDocuments” as “1” (i.e., one copy), “PageMediaSize” as “ISOA3” (i.e., sheet size: A3), “PageInputBin” as “Tray4” (i.e., feed tray: tray 4), and “DocumentStaple” as “StapleDualLeft” (i.e., staple: left two positions).

The prohibition JavaScript unit 44 obtains a list of hash values calculated at previous verification from the hash code table stored in the UserPropertybag 42 or the like beforehand (S102). FIG. 9A illustrates an example of the hash code table which retains hash codes (hash values) calculated from PrintTicket in a state where prohibition is not caused. According to this embodiment, two hash values of “1d43fe3c” and “4f3d274d” are stored. The hash code table may describe only the hash value calculated from the PrintTicket corresponding to the verification target. However, in consideration that combinations of the setting items of the printing functions and the setting values are limited, the hash code table may describe hash values calculated from all verified PrintTicket based on the assumption that the probability of conflict between the settings of the printing functions of the PrintTicket as the verification target is low even when the hash value calculated from PrintTicket agrees with a hash value calculated from other PrintTicket.

The prohibition JavaScript unit 44 determines whether or not the hash value calculated in S101 is present in the list of hash values obtained in S102 (S103). When the hash value calculated from the PrintTicket (1) is present in the list of hash values (S103: YES), no conflict is caused between the settings of the printing functions in the PrintTicket (1). In this case, execution of a prohibition verification process is unnecessary. Accordingly, the prohibition JavaScript unit 44 ends the prohibition process.

When the hash value calculated from the PrintTicket (1) is absent in the list of hash values (S103: NO), it is uncertain whether or not conflict is caused between the settings of the printing functions in the PrintTicket (1). Accordingly, the prohibition JavaScript unit 44 executes the prohibition verification process (S104). This step will be detailed later.

The prohibition JavaScript unit 44 calculates a hash value from the verified PrintTicket after solution of prohibition (S105). FIG. 8 illustrates an example of verified PrintTicket. In PrintTicket (2) shown in FIG. 8, a name attribute of Value node for “PageInputBin” is changed to “AutoSelect”, and a name attribute of Value node for “DocumentStaple” is changed to “None”, for solution to prohibition (see parts surrounded by broken lines in the figure).

The prohibition JavaScript unit 44 stores the hash value calculated in S105 in the hash code table (S106). FIG. 9B illustrates an example of the hash code table to which the hash value (“6a5b341f” in this embodiment) calculated from the verified PrintTicket (2) is added (see a part surrounded by a broken line in the figure).

As discussed above, the prohibition verification process is omitted when the hash value calculated from the PrintTicket as the verification target agrees with any one of hash values calculated at the time of previous verification and described in the hash code table. Accordingly, the prohibition process time decreases, wherefore reduction of the time required before printing start is achievable.

According to this embodiment, the hash value calculated from the PrintTicket as the verification target is stored in the hash code table. However, the hash value calculated from the PrintTicket as the verification target may be stored in the same PrintTicket. For example, as illustrated in FIG. 10A, the hash value (“1d43fe3c” in this example) calculated from the PrintTicket as the verification target is described in XML format at a predetermined position (such as end) of the PrintTicket. When the prohibition process is again required for the PrintTicket as the verification target, a hash value of the PrintTicket in a part other than the hash value added to the PrintTicket is again calculated, and compared with the hash value added to the PrintTicket. When these hash values agree with each other (see FIG. 10B), it is considered that no conflict is caused between the settings of the printing functions of the corresponding PrintTicket. Accordingly, the prohibition verification process is skipped. When the hash values do not agree with each other (see FIG. 10C), the calculated hash value (“4f3d274d” in this example) is added to a predetermined position of the PrintTicket. When the prohibition process is further required for the PrintTicket corresponding to the verification target, a hash value of the PrintTicket in a part other than the hash values added to the PrintTicket is compared with the plurality of hash values added to the PrintTicket. When the calculated hash value agrees with any one of the plurality of hash values, the prohibition verification process is skipped. Accordingly, even when hash values are added to PrintTicket, reduction of the prohibition process time, and therefore reduction of the time required before the printing start are similarly achievable.

The prohibition verification process executed in S104 is now described. In practicing the prohibition verification process, PrintTicket may be read every time the prohibition verification process is executed. In this case, however, PrintTicket in a large data size described in a structured language such as XML (Extensible Markup Language) needs to be read for each execution of the prohibition verification process, together with a part not needed for the prohibition verification process. Moreover, PrintTicket needs to be read for each of the prohibition condition expressions (described later). Accordingly, the necessary time for the prohibition verification process increases when the prohibition verification process is practiced in this way. On the other hand, the method according to this embodiment extracts setting items and setting values necessary for verification of prohibition from PrintTicket to create check data in a small data size, and executes the prohibition verification process with reference to the created check data to reduce the time required for the prohibition verification process to the minimum, even in such a case when omission of verification of prohibition based on comparison between hash values is not allowed. The prohibition verification process is hereinafter described with reference to the flowchart in FIG. 6.

Initially, the prohibition JavaScript unit 44 analyzes PrintTicket corresponding to a verification target (PrintTicket (1) in FIG. 7) to read “setting items” and “setting values” described in the PrintTicket (S201).

The prohibition JavaScript unit 44 creates check data (setting state table in this embodiment) based on a setting item list created beforehand (S202). FIG. 11 illustrates an example of the setting item list which shows setting item names contained in the prohibition condition expressions. The prohibition JavaScript unit 44 puts one or a plurality of “setting items” and one or a plurality of “setting values” read from the PrintTicket into the setting state table based on the setting item list. FIG. 12 illustrates an example of the setting state table created based on the PrintTicket (1) illustrated in FIG. 7 and the setting item list illustrated in FIG. 11. “Setting items” correspond to name attributes of Feature node or ParameterInit node of PrintTicket. “Setting values” correspond to values of Value node or name attributes of Option node of PrintTicket. “Changed” is a change status flag which becomes true when the setting values of this table are changed. While the setting item list is created beforehand in this embodiment, one or a plurality of setting items contained in the prohibition condition expressions (described later) may be designated so that only the designated setting items are read from PrintTicket. In addition, while the check data in the form of the setting state table is used in this embodiment, the check data is not required to have table structure. Data format of the check data may be of arbitrary types, such as xml format similarly to PrintTicket, and text format. In case of text format, the data size of the check data decreases, and the reading process becomes easier. Accordingly, the processing time becomes still shorter.

The prohibition JavaScript unit 44 reads the prohibition condition expressions line by line for determining conflict between settings of the printing functions (S203). FIG. 14 illustrates an example of the prohibition condition expressions. More specifically, the expression on the first line shows that “sheet size=A3” and “feed tray=tray 4” are changed to “feed tray=automatic”. The expression on the second line shows that “sheet size=A3” and “staple=left two positions” are changed to “staple=none”.

The prohibition JavaScript unit 44 executes verification of prohibition with reference to the setting state table (1) illustrated in FIG. 12 and the prohibition condition expressions read in S203 (S204). More specifically, the prohibition JavaScript unit 44 determines whether or not the combinations of the setting items and the setting values described in the setting state table (1) illustrated in FIG. 12 agree with the combinations specified in the prohibition condition expressions.

When prohibition is detected based on the verification of prohibition in S204 (S205: YES), the prohibition JavaScript unit 44 changes the setting values in accordance with the prohibition condition expressions to solve the prohibition, and rewrites the setting value of the setting item causing conflict to a setting value not causing prohibition (S206). FIG. 13 illustrates an example of the setting state table after completion of verification of prohibition. According to this example, the setting value of a setting item “psk: PageInputBin” is changed to “psk: AutoSelect”, while a change status flag “Changed” is changed to “true”. In addition, the setting value of a setting item “psk: DocumentStaple” is changed to “psk: None”, while a change status flag “Changed” is changed to “true” (see a part surrounded by a broken line in the figure). When no prohibition is detected (NO in S205), the prohibition JavaScript unit 44 skips this step and proceeds to S207 without making changes.

The prohibition JavaScript unit 44 determines whether or not the next prohibition condition expression is present (S207). When the next prohibition condition expression is present, the prohibition JavaScript unit 44 returns to S203 to repeat similar processes until no prohibition condition expression shown in FIG. 14 remains. After completion of all the prohibition condition expression determinations, the prohibition JavaScript unit 44 writes the prohibition-solved setting values to the PrintTicket (S208). More specifically, the “setting values” of the “setting items” where the change status flags “Changed” have been changed to “true” are written to the PrintTicket with reference to the setting state table (2) illustrated in FIG. 13. FIG. 8 illustrates an example of the PrintTicket to which the setting values have been written. In this case, the setting value of the setting item “psk: PageInputBin” is changed to “psk: AutoSelect”, while the setting value of the setting item “psk: DocumentStaple” is changed to “psk: None” similarly to the setting state table (2).

Accordingly, setting items and setting values of the setting item list created beforehand are read from PrintTicket to create the setting state table in a small data size, and the prohibition verification process is executed with reference to the created setting state table. By this method, the time required for verifying prohibition considerably decreases in comparison with a conventional method which reads all PrintTicket in a large data size containing parts not necessary for verifying prohibition for each prohibition condition expression.

Discussed hereinafter are effects of reduction of the prohibition process time as a result of control based on comparison between hash values for omitting verification of prohibition illustrated in the flowchart in FIG. 5 (control corresponding to a feature of this embodiment), and control with reference to the setting state table for verifying prohibition shown in the flowchart in FIG. 6 (control executed as necessary). FIGS. 15A to 15C illustrate comparisons between measurement results (averages of five measurement values) of the processing time before application of the controls, and measurement results of the processing time after application of the controls. Measurement conditions are similar to those of Table 1. Measurement target data “SP03P_AC.pdf” corresponds to the 1st page, while “J9.doc” corresponds to the 5th page. The measurements are performed under the environment of OS:Windows8 Pro, CPU:Intel® Core™ i5-2400@3.10 GHz, Memory:8.00 GB, HDD:400 GB (Remaining:100 GB), Application:Adobe reader 11.0.3, Application:Microsoft Word 2010.

FIG. 15A shows processing time required when only the control based on comparison between hash values for omitting verification of prohibition is applied, and does not reflect the result of the control with reference to the setting state table for verifying prohibition (i.e., prohibition is verified for PrintTicket read for each prohibition condition expression). When the control based on comparison between hash values or omitting verification of prohibition is applied, approximately 30% to 40% of the prohibition process time decreases in comparison with the corresponding time required when this control is not applied, as can be seen from FIG. 15A. Accordingly, approximately 17% to 20% of the time required for completion of printing data creation decreases.

FIG. 15B shows processing time required when only the control with reference to the setting state table for verifying prohibition is applied, and does not reflect the result of the control based on comparison between hash values for omitting verification of prohibition (i.e., verification of prohibition is executed every time a request of the prohibition process is issued). When the control with reference to the setting state table for verifying prohibition is applied, approximately 40% of the prohibition process time decreases in comparison with the corresponding time required when this control is not applied, as can be seen from FIG. 15B. Accordingly, approximately 20% to 22% of the time required for completion of printing data creation decreases.

FIG. 15C shows processing time required when the control based on comparison between hash values for omitting verification of prohibition, and the control with reference to the setting state table for verifying prohibition are both applied. When both the controls are applied, approximately 60% of the prohibition process time decreases in comparison with the corresponding time required when these controls are not applied, as can be seen from FIG. 15C. In this case, approximately 30% to 40% of the time required for completion of printing data creation decreases. Accordingly, a remarkable reduction effect is produced by a combination of the two controls.

The present invention is not limited to the embodiment described herein. The configuration of the printer driver, and the prohibition process control method for the printer driver may be modified in appropriate manners without departing from the scope of the present invention.

For example, while the printer driver of Version 4 has been discussed in the foregoing embodiment, the present invention is similarly applicable to arbitrary types of printer driver executing a prohibition process in a script language such as JavaScript.

The present invention is applicable to printer driver executing a prohibition process in a script language such as JavaScript, and more particularly to printer driver of Version 4 and a recording medium recording this printer driver.

According to an embodiment of the present invention, the printer driver and the prohibition process control method for the printer driver according to the present invention can efficiently execute the prohibition process for determining conflict between the settings of the printing functions.

This advantages is offered under the control of the printer driver (prohibition JavaScript unit) which calculates identity determination information such as a hash value beforehand from PrintTicket in a state where prohibition is not caused, stores the calculated identity determination information in a table or the same PrintTicket, calculates identity determination information from the PrintTicket at a start of the prohibition process for the PrintTicket, compares the stored identity determination information and the calculated identity determination information. When the stored identity determination information and the calculated identity determination information agree with each other, a prohibition verification process is skipped. When the stored identity determination information and the calculated identity determination information disagree with each other, the prohibition verification process is executed. In this case, the identity determination information calculated from the verified PrintTicket is stored.

According to this control, the prohibition verification process is not repeated a plurality of number of times for the same PrintTicket. Accordingly, the prohibition process time decreases even in case of the prohibition process executed in a script language such as JavaScript, wherefore reduction of the time required before the printing start is achievable.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A printer driver which operates in a computer device issuing an instruction of printing to a printing device, and executes a prohibition process in a script language for verifying and solving prohibition that causes conflict between settings of printing functions of the printing device, under the printer driver, the computer device executing:
a first process that calculates identity determination information beforehand from PrintTicket in a state where prohibition is not caused, and stores the calculated identity determination information;
a second process that calculates identity determination information from the PrintTicket at a start of the prohibition process for the PrintTicket; and
a third process that compares the identity determination information stored in the first process and the identity determination information calculated in the second process, wherein
the first process through the third process are performed in this order,
when the identity determination information stored in the first process and the identity determination information calculated in the second process agree with each other, the third process does not execute verification of prohibition, and
when the identity determination information stored in the first process and the identity determination information calculated in the second process disagree with each other, the third process executes verification of prohibition, calculates identity determination information from the PrintTicket in a state where the prohibition has been solved, and additionally stores the calculated identity determination information.

2. The printer driver according to claim 1, wherein the identity determination information is a hash value or a check sum.

3. The printer driver according to claim 1, wherein
a plurality of sets of the identity determination information are stored in the first process, and
the third process does not execute verification of the prohibition when any one of the plurality of sets of the identity determination information stored in the first process agrees with the identity determination information calculated in the second process.

4. The printer driver according to claim 1, wherein the printer driver is a printer driver of Version 4 that operates on an operating system of Windows (registered trademark).

5. The printer driver according to claim 1, wherein the identity determination information is stored in the same PrintTicket.

6. The printer driver according to claim 4, wherein the identity determination information is stored in UserPropertybag of a Printer Driver core unit.

7. The printer driver according to claim 1, wherein, when the identity determination information stored in the first process and the identity determination information calculated in the second process disagree with each other, the third process obtains setting items and setting values of the printing functions from the PrintTicket to create check data, executes verification of the prohibition with reference to the check data, and rewrites the setting value of the setting item contained in the PrintTicket and causing the prohibition into a setting value causing no prohibition.

8. The printer driver according to claim 7, wherein the third process rewrites the setting value contained in the check data and corresponding to the setting item causing the prohibition into a setting value causing no prohibition, adds information to the check data to indicate that the setting value causing the prohibition has been rewritten, and rewrites the setting values contained in the PrintTicket into the setting values of the check data with reference to the information added to the check data.

9. The printer driver according to claim 7, wherein
the PrintTicket is formed in XML (Extensible Markup Language) format, and
the check data is formed in text format.

10. A prohibition process control method for a printer driver which operates in a computer device issuing an instruction of printing to a printing device, and executes a prohibition process in a script language for verifying and solving prohibition that causes conflict between settings of printing functions of the printing device, the method comprising:
a first process that calculates identity determination information beforehand from PrintTicket in a state where prohibition is not caused, and stores the calculated identity determination information;
a second process that calculates identity determination information from the PrintTicket at a start of the prohibition process for the PrintTicket; and
a third process that compares the identity determination information stored in the first process and the identity determination information calculated in the second process, wherein
when the identity determination information stored in the first process and the identity determination information calculated in the second process agree with each other, the third process does not execute verification of prohibition, and
when the identity determination information stored in the first process and the identity determination information calculated in the second process disagree with each other, the third process executes verification of prohibition, calculates identity determination information from the PrintTicket in a state where the prohibition has been solved, and additionally stores the calculated identity determination information.

11. The prohibition process control method for the printer driver according to claim 10, wherein the identity determination information is a hash value or a check sum.

12. The prohibition process control method for the printer driver according to claim 10, wherein
a plurality of sets of the identity determination information are stored in the first process, and
the third process does not execute verification of the prohibition when any one of the plurality of sets of the identity determination information stored in the first process agrees with the identity determination information calculated in the second process.

13. The prohibition process control method for the printer driver according to claim 10, wherein the printer driver is a printer driver of Version 4 that operates on an operating system of Windows (registered trademark).

14. The prohibition process control method for the printer driver according to claim 10, wherein the identity determination information is stored in the same PrintTicket.

15. The prohibition process control method for the printer driver according to claim 13, wherein the identity determination information is stored in UserPropertybag of a Printer Driver core unit.

16. The prohibition process control method for the printer driver according to claim 10, wherein, when the identity determination information stored in the first process and the identity determination information calculated in the second process disagree with each other, the third process obtains setting items and setting values of the printing functions from the PrintTicket to create check data, executes verification of the prohibition with reference to the check data, and rewrites the setting value of the setting item contained in the PrintTicket and causing the prohibition into a setting value causing no prohibition.

17. The prohibition process control method for the printer driver according to claim 16, wherein the third process rewrites the setting value contained in the check data and corresponding to the setting item causing the prohibition into a setting value causing no prohibition, adds information to the check data to indicate that the setting value causing the prohibition has been rewritten, and rewrites the setting values contained in the PrintTicket into the setting values of the check data with reference to the information added to the check data.

18. The prohibition process control method for the printer driver according to claim 16, wherein
the PrintTicket is formed in XML (Extensible Markup Language) format, and
the check data is formed in text format.
